(19) United States
(12) Patent Application Publication
(10) Pub. No.: US 2010/0309008 A1
(43) Pub. Date: Dec. 9, 2010

(54) CONTROLLING OPERATION OF A POSITIONING MODULE

(75) Inventor: Mika Heino Laaksonen, Oulu (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/745,524

(22) PCT Filed: Nov. 30, 2007
(86) PCT No.: PCT/EP07/63105

§ 371 Date: May 28, 2010

(51) Int. Cl. G08B 21/00

(52) U.S. Cl. 340/657

(57) ABSTRACT

Apparatus comprises a module, a magnetometer, and a controller. The module has an operation or output dependent on a location of the apparatus. The magnetometer includes a magnetic sensor arrangement. The controller is arranged to control operation of the module dependent on signals provided at an output of the magnetometer.

### FIELD OF THE INVENTION

This invention relates to apparatus comprising a module and a magnetometer. The invention relates also to a method of controlling operation of a module.

### BACKGROUND TO THE INVENTION

Battery-powered portable devices including positioning receivers, such as receivers for operating in the global positioning system (GPS), are well known. Initially, GPS receivers merely read out a location of the receiver on a display. The location is determined by performing a location fix. This involves receiving signals from positioning system transmitters, typically low earth orbit satellites, and performing some calculations on the basis of information derived from the received signals. Operation of the GPS receiver consumes a significant amount of charge from the receiver's battery.

It is now relatively comment to incorporate GPS receivers in navigation devices. Navigation devices intended for use in vehicles typically are connected to a source of electrical power in the vehicle, so the power consumption of those devices is not of particular concern. It is now known also to include GPS receivers in devices such as mobile telephones and personal digital assistants (PDAs), which will have a number of other capabilities, typically including voice and/or data communication by way of a radio network. In such devices, the power consumption is of more interest to users since a high power consumption equates to shorter battery life.

The invention was made in this context.

### SUMMARY OF THE INVENTION

A first aspect of the invention provides apparatus comprising:
a module, the module having an operation or output dependent on a location of the apparatus;
a magnetometer including a magnetic sensor arrangement, and
a controller,

wherein the controller is arranged to control operation of the module dependent on signals provided at an output of the magnetometer.

This contrasts with other means for detecting a change in location of apparatus. In particular, accelerometer-based means can provide outputs when there is some movement without any significant change in location. If the module were to be controlled on the basis of accelerometer sensor data, the operation of the module could often be controlled unnecessarily in the absence of a change in location.

Since apparatus, particularly portable devices, can be provided with magnetometers for the purpose of providing the apparatus with a compass function, the invention can require no or relatively little additional hardware and relatively little additional software to provide location-dependent control of the module. In the case of a mobile communications device including a compass function and a navigation function, for example, the calibration arrangement of the magnetometer can be used with a simple process to control operation of a positioning module associated with the navigation function with relatively little dedicated software.

There is a first disadvantage with the apparatus in that operation of the module may be controlled when the apparatus does not change its location, for instance if a magnet or something with magnetic properties (for instance a material including a significant Iron content) is moved in the vicinity of the apparatus. There is a second disadvantage in that, in some circumstances, location can change substantially without sufficient change in magnetic field to be detected as a change in location. In such cases, the module could be controlled less than optimally. However, the inventor considers that these are acceptable considering the benefits that can be obtained from the invention.

The apparatus may further comprise a calibrator operable to perform a calibration process utilising signals provided at the output of the magnetometer sensor arrangement, wherein the controller is arranged to control the module dependent on an output of the calibrator.

The controller may be arranged to control the module dependent on a calculation involving accuracy estimation data provided by the calibrator. Here, the controller may be arranged to control the module dependent on a determination as to whether accuracy estimation data provided by the calibrator indicates a change from a state of relatively high accuracy to a state of relatively low accuracy.

The controller may be arranged to control the module dependent on a determination as to whether data provided by the calibrator has changed to a significant degree within a period or since an event.

The controller may be arranged to control the module dependent on a calculation involving correction parameter data provided by the calibrator.

The controller may be operable to control the module to be operated less frequently for periods when the calibrator indicates that calibration is being performed relatively than a frequency at which the module is operated for periods when the calibration arrangement indicates that calibration is being performed relatively frequently.

The controller may be operable to increase a frequency of operation of the module in response to a determination that the output of the calibrator indicates that the magnetic field to which the apparatus is exposed has changed from being relatively static to being relatively dynamic.

The controller may be operable to decrease a frequency of operation of the module in response to a determination that the output of the calibrator indicates that the magnetic field to which the apparatus is exposed has changed from being relatively dynamic to being relatively static.

These features can be particularly useful where the module is one which does not need to be operational when the apparatus remains at a location. This is the case with positioning modules, such as GPS receivers, although the invention is more broadly applicable than this. Using these features of the invention, power consumption of the apparatus may be reduced by reducing unnecessary powering-up of the module.

The module may be a positioning module. The invention has particular benefits when applied to apparatus including a positioning module. In particular, using data from a calibration process allows the positioning receiver to remain powered down when the location of the apparatus does not change significantly. This is particularly important in the case of GPS receivers, for which obtaining a location fix can consume a considerable amount of energy and thus impose a significant drain on resources of a battery of the apparatus. Using the invention, the battery life of the apparatus may be considerably increased by reducing the number of location fixes that are performed in a given period of time.

A second aspect of the invention provides a method comprising:
receiving signals from a magnetometer including a magnetic sensor arrangement, and
controlling a module having an operation or output dependent on a location of the apparatus dependent on the signals

A third aspect of the invention provides a medium having stored thereon computer code for controlling computer apparatus, comprising:
computer code for receiving signals from a magnetometer including a magnetic sensor arrangement, and
computer code for controlling a module having an operation or output dependent on a location of the apparatus dependent on the signals.

### BRIEF DESCRIPTION OF THE DRAWINGS

Embodiments of the present invention will now be described, by way of example only, with reference to the accompanying drawings in which:

FIG. 1 is a schematic diagram of an embodiment of apparatus according to the present invention;

FIG. 2 is a flow chart illustrating an azimuth calculation and calibration process running on the FIG. 1 apparatus;

FIG. 3 is a flow chart illustrating a power state determination process running on the FIG. 1 apparatus; and

FIG. 4 is a flow chart illustrating operation of a process for controlling operation of a module of the FIG. 1 apparatus depending on a power state.

### DESCRIPTION OF THE EMBODIMENTS

In the drawings, reference numerals are re-used for like elements.

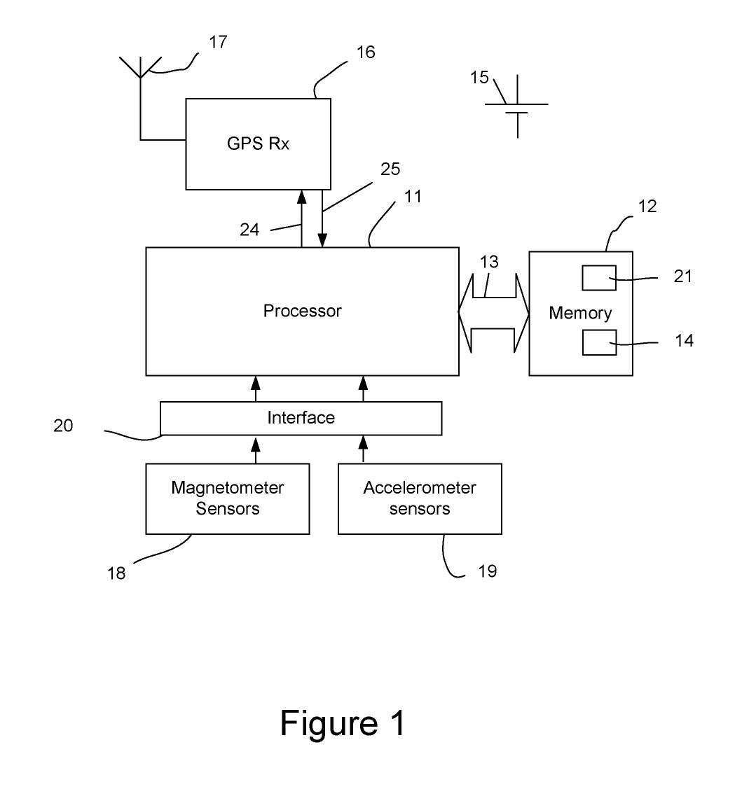

Referring to FIG. 1, a device 10 according to the present invention is shown. The device comprises a processor 11 and a memory 12 connected to one another by a bus 13. The device 10 includes a power supply in the form of a battery 15, which powers all of the components of the device 10 that require electrical power.

The device 10 includes a GPS receiver 16 connected to an antenna 17. The GPS receiver 16 may take any suitable form.

The device 10 also includes a magnetometer sensor arrangement 18. The magnetometer sensor arrangement 18 may take any suitable form. For instance, it may be a magnetometer sensor arrangement of the type shown and described in U.S. Pat. No. 7,177,779. Magnetometers sensor arrangements of the type shown in FIG. 1 are well known.

The device 10 also includes accelerometer sensors 19. These may take any suitable form.

The processor 11 is able to receive sensor data from the magnetometer sensor arrangement 18 and the accelerometer sensors 19 by way of their connection to the processor 11 via an interface 20. The processor 11 and the magnetometer sensor arrangement 18 can be said to constitute a magnetometer.

The processor 11 is connected to the GPS receiver 16 by a control line 24. A data line 25 connects the GPS receiver and the processor 11, for the purpose of carrying positioning data to the processor 11.

Operation of the device 10 will now be described. The processor 11 is operable to perform certain functions according to plural computer programs, indicated in the Figure generally at 14, stored in the memory 12. These functions include a compass function and a navigation function. Other functions may also be present, as is described in some detail below.

The compass function allows the device 10 to inform a user of the heading of the device, i.e. the direction in which the device is pointing. In this specification, the term ‘heading’ is used interchangeably with direction, azimuth and orientation. This is achieved by using an azimuth calculation process to calculate the direction of magnetic north in relation to the device 10. To achieve this, the processor 11 uses data from the magnetometer sensor arrangement 18 to calculate the orientation of the sensors 18 and thus the device 10. The azimuth calculation process is a computer program, one of a number of programs indicated at 21 in the Figure, which is stored in the memory 12 and which runs on the processor 11

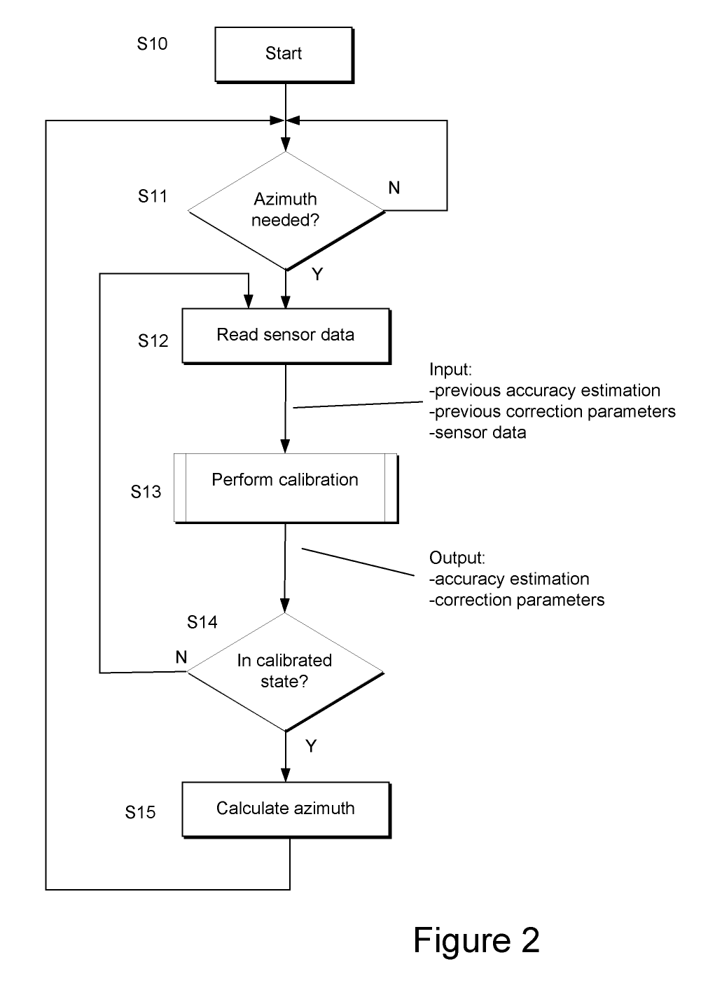

Operation of the processor 11 in carrying-out the azimuth calculation and calibration process will now be described with reference to FIG. 2. This process runs continuously in the background whenever azimuth information may be required.

The operation starts at step S10. At step S11, it is determined whether an azimuth measurement is needed. Until an azimuth measurement is needed, the process remains looping around step S11. Once an azimuth measurement is needed, the operation proceeds to step S12. Here, the processor reads sensor data provided by the magnetometer sensor arrangement 18, using the interface 20.

At step S13, the process performs calibration. The exact calibration algorithm used is not critical to this invention. An explanation of the calibration step and its purpose now follows.

Calibration step S13 divides the readings of the sensors into two parts, in particular (a) the magnetic field produced by the earth's geomagnetism and (b) other sources of magnetic fields. As will be appreciated, the magnetic field produced by the earth's geomagnetism changes when the azimuth of the magnetometer sensor arrangement 18 changes, and the magnetic field produced by other sources of magnetic fields changes depending on other, external factors. Thus, the sensor data can change even if there is no change in azimuth. This can happen when the device moves to a location where different magnetic fields are present or when a magnetic object in the vicinity of the device 10 is moved.

As is shown in FIG. 2, the output of the calibration step S13 is data comprising an accuracy estimation and correction parameters. This data can be used for removing the effect other sources of magnetic fields from the magnetometer sensor reading. The data also is used as an input to the calibration step S13 the next time it is performed.

The process uses the accuracy estimate to determine at step S14 whether the magnetometer is calibrated. This may involve a simple comparison of the accuracy estimate to a threshold. If the magnetometer is not calibrated, the process returns to step S12, where new sensor data is read. The new sensor data, the accuracy estimate and the correction parameters are then used by the calibration process S13 to provide a new accuracy estimate and new correction parameters. This is repeated until step S14 determines that the magnetometer is calibrated, when the process progresses to calculate azimuth at step S15. This step utilises the sensor data, the accuracy estimate and the correction parameters to calculate the orientation of the device 10. Simply speaking, the step S15 subtracts from the magnetic field produced by the earth's geomagnetism the magnetic field produced by other sources of magnetic fields. After step S15, the process returns to step S10.

The azimuth measurement thus obtained can be used functions of the device 10 as required. For instance, the azimuth information can be used by the processor 11, through the programs 14, to provide a compass function, for instance to display a graphical representation of a compass needle on a display (not shown) of the device 10. The azimuth information may instead be combined with measurements resulting from data provided by the accelerometer sensors 19. Such combination can allow the processor 11 to detect user interaction gestures, and thereby accomplish a user input. Such may be of particular use in gaming applications. In such cases, a representation of magnetic north is not presented to the user.

The step S15 can be omitted if magnetometer data is required for some purpose other than azimuth measurement.

The GPS receiver 16 is responsive to an actuation signal received from the processor 11 over the control line 24 to perform a location fix. Once a fix has been performed, positioning data is relayed to the processor 11 by the data line 25. The processor 11 can perform any amount of the calculations needed to determine the location of the device 10. On the one hand, most of the calculation can be performed within the GPS receiver 16. On the other hand, most of the calculation can be performed by the processor 11. In either case, following performance of a location fix, the processor 11 is aware of the location of the device 10. This information can be used in any convenient manner. For instance, the location information can be used by the navigation function on the device 10. Alternatively, it can be used to provide location-dependent services. Each location fix consumes an amount of charge from the battery 15.

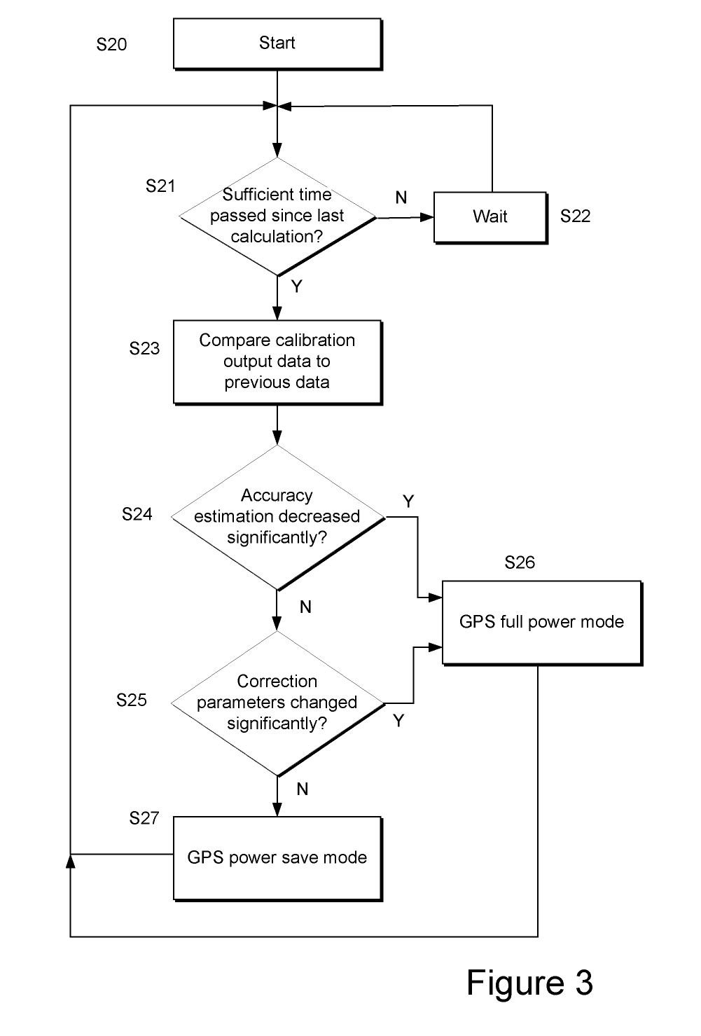

A power state setting process running on the processor 11 will now be described with reference to FIG. 3. The power state setting process is a computer program 21 stored in the memory 12 and which runs on the processor 11. The process starts at step S20. At step S21 a determination is made as to whether a sufficient time has passed since a power mode setting calculation was last performed. The process remains in a loop including a delay step S22 until a sufficient time has passed, when the process progresses to step S23. Here, the calibration output data provided by the calibration step S13 of FIG. 2 is compared to the corresponding data from a previous run of the process. As explained above, the calibration output data includes an accuracy estimation and correction parameters.

At step S24, the process determines whether the accuracy estimation has decreased to a significant degree. This can be carried out in any suitable manner. For instance, the difference between the current accuracy estimate and the previous accuracy estimate can be compared to a threshold, with the result of the step being dependent on whether or not the threshold is exceeded. In the event of a negative determination, the process continues to step S25.

At step S25, the process determines whether the correction parameters have changed to a significant degree. This can be carried out in any suitable manner. For instance, a measure of the difference between the current correction parameters and the previous correction parameters can be compared to a threshold, with the result of the step being dependent on whether or not the threshold is exceeded.

In the event of a positive determination from either step S24 or step S25, the process flows to step S26. Here, the device is placed in full power mode, the implications of which are explained in more detail below. If the device 10 was already in full power mode, then step S26 effects no change. If the device 10 was not already in full power mode, then step S26 causes the full power mode to be entered and the pre-existing mode (power save mode) to be exited. The device 10 can be in only one of the two modes at a given time.

In the event of a negative determination at step S25, the process proceeds to step S27. Steps S26 and S27 are in parallel with one another. In step S27, the device is placed in GPS power save mode, the implications of which are explained in more detail below. If the device 10 was already in power save mode, then step S26 effects no change. If the device 10 was not already in power save mode, then step S26 causes the power save mode to be entered and the pre-existing mode (full power mode) to be exited. The device 10 can be in only one of the two modes at a given time.

After steps S26 and S27, the process returns to step S21. Steps S21 and S22 ensure that steps S23 to S27 are not performed too frequently.

The power state setting process sets a power mode dependent on data output by the calibration state. In particular, the power state setting process sets a power mode dependent on an inference from the data as to whether the device 10 is stationary of whether it is moving. This inference is drawn from the accuracy information and from changes in the correction parameters.

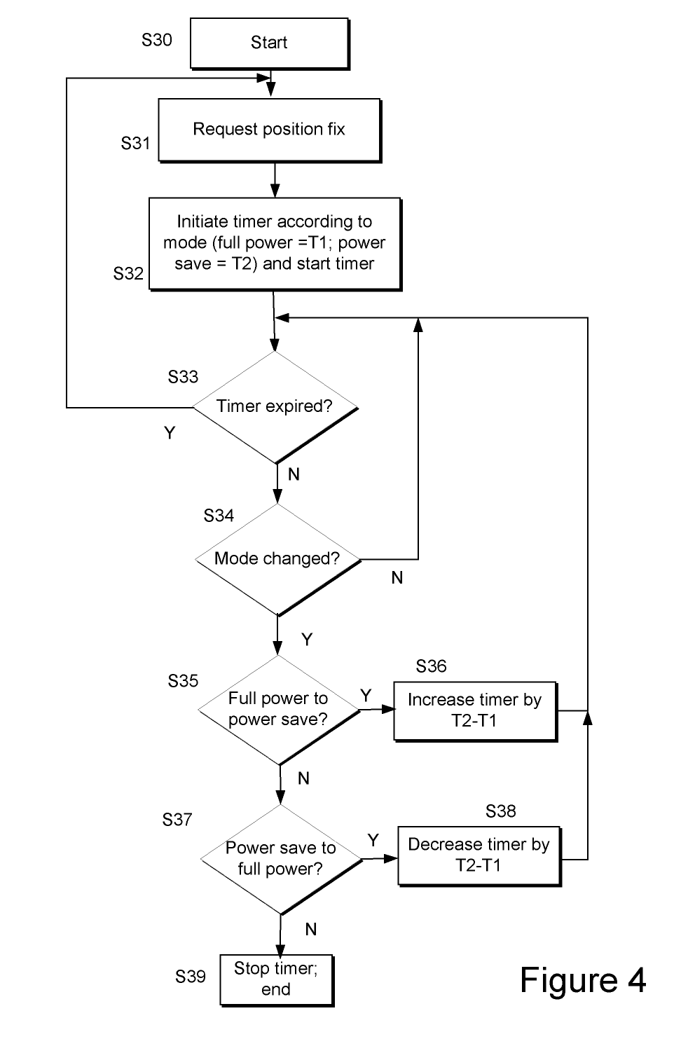

The processor 11 operates, under control of a program 21, to utilise data resulting from the calibration step S23 in determining how to operate the GPS receiver 16. This will now be described in detail with reference to FIG. 4, which is a flow chart illustrating operation of a process for controlling operation of the GPS receiver 16.

The process for controlling operation of the GPS receiver 16 runs on the processor 11 when the GPS receiver 16 is required to be operational. The process begins at step S30 when the GPS receiver 16 becomes operational. This occurs in response to a software input, for instance instigated by the navigation function of the device 10. At step S31, the process requests a position fix. This involves sending a control signal over the control line 24 to the GPS receiver 16.

At step S32, the process initiates a timer depending on the power mode, as set by the process shown in FIG. 3. If the power mode is full power mode, the timer is set to a value of T1 If the mode is power save mode, the timer is set to a value of T2. For instance, T1 may be 15 seconds and T2 may be 60 seconds. After timer initiation, the timer is started. The timer runs at real time, i.e. independently of the process.

At step S33, it is determined whether the timer has expired. If it has, the process returns to step S31, following which a position fix is requested and the timer is again initiated and started at steps S31 and S32. When step S33 determines that the timer has not expired, the process continues to step S34. Here, it is determined whether the power mode has changed since last performance of the step S34. The power mode can change according to the process shown in FIG. 3. If the power mode has not changed, the process returns to step S33. This ensures that the process sits in a loop until either the timer expires or there is a change in the power mode.

If step S34 determines that there has been a change in power mode, the process proceeds to step S35. Here it is determined whether the change was from full power mode to power save mode. If it was, at step S36 the process increases the timer value by an amount equal to the difference between the timer values T2 and T1. For instance, the difference could be 45 seconds. If it was not, the process determines at step S37 whether the change was from power save mode to full power mode. If it was, at step S38 the process decreases the timer value by the difference between the timer values T1 and T2. This may result in a negative timer value. A negative timer value indicates an expired timer. Following step S36 or step S38, the process returns to step S33. If step S37 yields a negative result, it can be inferred that the GPS receiver 26 is required to be switched-off. In this case, the process at step S39 stops the timer and the process ends.

The effect of the process for controlling operation of the GPS receiver 16 is to request position fixes at intervals dependent on the power mode, which is determined by the power state setting process on the basis of data provided by the calibration step S13 of FIG. 2. The position fixes are separated by higher time intervals (i.e. are further apart in time) when in the power save mode than when in full power mode. The effect of the process is also that, if the power mode changes between position fixes, the timer value is adjusted such that the next position fix is made in accordance with the new power mode. In particular, if the mode changes to full power mode, the next position fix is brought forward. This is particularly useful since it indicates a transition from a relatively fixed location state to a moving state. If the mode changes to power save mode, indicating a transition from a moving state to a relatively fixed state, the next position fix is deferred.

This has a number of effects. When in the power save mode, the processor 11 is arranged to send location fix request signals to the GPS receiver 16 at relatively long intervals. Thus, when the data provided by the calibration step S23 indicates that the location of the device 10 is not changing to any significant degree, the power consumption of the GPS receiver 16 is relatively low. At times when the data provided by the calibration step S23 indicates that the location of the device 10 is changing sufficiently to affect calibration of the magnetometer, the processor 11 is arranged to send location fix requests to the GPS receiver 16 at shorter intervals. Thus, the device 10 is arranged to perform location fixes more frequently when the location of the device is changing to a more significant degree.

Thus, in the power save mode the GPS receiver 16 consumes less charge from the battery 15 than it does when in the full power mode. This does not substantially reduce the effectiveness of the device 10 since, when the device 10 is in the power save mode, the device 10 usually is not moving to any significant degree. Thus, in this mode, it is inferred that the location of the device 10 is relatively fixed and that the GPS receiver 16 would return location information which did not differ substantially from one location fix to the next location fix. In this way, a significant reduction in the amount of power consumed can be achieved without significantly impeding the effectiveness of the navigation function of the device 10, or other functions which use data provided by the module. Moreover, in respect of a device including a magnetometer 18 and a GPS receiver 16, this power saving can be achieved with the simple inclusion of some additional software for implementing the FIGS. 3 and 4 processes.

In other embodiments, the device is arranged to operate substantially as described above, with the exception that the power save mode is replaced with a power off mode. In this case, position fix requests are not sent at all—i.e. the GPS receiver 16 remains powered-down—when the magnetometer sensor outputs are indicative of the device being in a relatively stationary condition.

In other embodiments, there are three power states. The device is controlled to enter a state which is most appropriate having regard to magnetometer sensor outputs. Where the outputs indicate a rapidly moving device, the device is placed in a full power mode. In this mode, position fix requests are issued relatively frequently. Where the outputs indicate a stationary device, the device is placed in a power save mode, in which position fix requests are issued relatively infrequently. Where the outputs indicate a slowly moving device, the device is placed in an intermediate power mode. In this mode, position fix requests are issued at a rate between the frequent and infrequent rates. In further embodiments, there are more than three power states.

In the above, the processor 11 is arranged to send location fix requests to the GPS receiver 16 at different intervals depending only on data provided by the calibration step S13. This is just one embodiment, and numerous variations are possible. For instance, in other embodiments, position fix requests are issued at intervals depending also on other inputs, for instance one or more of GPS-determined location, GPS speed and accelerometer inputs. In other embodiments, position fix requests are issued at intervals depending only on magnetometer and accelerometer sensor data. This embodiment is shown in FIG. 1.

Also, the processes of FIGS. 3 and 4 rely on the azimuth calculation and calibration process of FIG. 2 running. If the azimuth calculation and calibration process is not running, for instance because azimuth measurements are not required, the frequency of instructing position fixes may be carried out conventionally. Alternatively, the device may be arranged such that, whenever the GPS receiver 26 is required to be in operation, the azimuth calculation and calibration process is run. This has the effect of the running of the azimuth calculation and calibration process and operation of the magnetometer sensor arrangement consuming power when otherwise this might not be the case, but power saving in the GPS receiver 16 would in many situations more than compensate for this.

It will be appreciated that the above embodiments are purely illustrative, and that the scope of the invention is limited only by the claims. Various alternatives are possible.

For instance, it is not essential that the processes of FIG. 3 and/or FIG. 4 are implemented purely as software. For instance, either or both could be implemented in hardware, or in a combination of hardware of software. Alternatively, one or both of the processes could be implemented in a processor or other controller separate from the main processor 11.

Also, although the power state setting process uses accuracy estimation and correction parameters, it will be appreciated that other calibration output data can be used to infer a motion state of the device 10, and on that basis control the module.

Furthermore, the embodiments have been described with reference to control of a GPS receiver device, which could be termed a GPS receiver module. However, it will be appreciated that the invention is applicable to control of any module having an operation or output dependent on a location of the host apparatus.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon. Moreover, it should be appreciated that those skilled in the art, upon consideration of the present disclosure, may make modifications and/or improvements on the apparatus hereof and yet remain within the scope and spirit hereof as set forth in the following claims.

1. Apparatus comprising:
a module, the module having an operation or output dependent on a location of the apparatus;
a magnetometer including a magnetic sensor arrangement, and
a controller,
wherein the controller is arranged to control operation of the module dependent on signals provided at an output of the magnetometer.

2. Apparatus as claimed in claim 1, further comprising a calibrator operable to perform a calibration process utilizing signals provided at the output of the magnetometer sensor arrangement, wherein the controller is arranged to control the module dependent on an output of the calibrator.

3. Apparatus as claimed in claim 2, wherein the controller is arranged to control the module dependent on a calculation involving accuracy estimation data provided by the calibrator.

4. Apparatus as claimed in claim 3, wherein the controller is arranged to control the module dependent on a determination as to whether accuracy estimation data provided by the calibrator indicates a change from a state of relatively high accuracy to a state of relatively low accuracy.

5. Apparatus as claimed in claim 2, wherein the controller is arranged to control the module dependent on a determination as to whether data provided by the calibrator has changed to a significant degree within a period or since an event.

6. Apparatus as claimed in claim 2, wherein the controller is arranged to control the module dependent on a calculation involving correction parameter data provided by the calibrator.

7. Apparatus as claimed in claim 2, wherein the controller is operable to control the module to be operated less frequently for periods when the calibrator indicates that calibration is being performed relatively than a frequency at which the module is operated for periods when the calibration arrangement indicates that calibration is being performed relatively frequently.

8. Apparatus as claimed in claim 2, wherein the controller is operable to increase a frequency of operation of the module in response to a determination that the output of the calibrator indicates that the magnetic field to which the apparatus is exposed has changed from being relatively static to being relatively dynamic.

9. Apparatus as claimed in claim 2, wherein the controller is operable to decrease a frequency of operation of the module in response to a determination that the output of the calibrator indicates that the magnetic field to which the apparatus is exposed has changed from being relatively dynamic to being relatively static.

10. A method comprising:
receiving signals from a magnetometer including a magnetic sensor arrangement, and
controlling a module of an apparatus having an operation or output dependent on a location of the apparatus dependent on the signals.

11. A method as claimed in claim 10, further comprising:
using a calibrator to perform a calibration process utilizing the signals; and
controlling the module dependent on an output of the calibrator

12. A method as claimed in claim 11, comprising controlling operation of the module dependent on a calculation involving accuracy estimation data provided by the calibrator.

13. A method as claimed in claim 12, comprising controlling the module dependent on a determination as to whether accuracy estimation data provided by the calibrator indicates a change from a state of relatively high accuracy to a state of relatively low accuracy.

14. A method as claimed in claim 11, comprising controlling the module dependent on a determination as to whether data provided by the calibrator has changed to a significant degree within a period or since an event.

15. A method as claimed in claim 11, comprising controlling the module dependent on a calculation involving correction parameter data provided by the calibrator.

16. A method as claimed in claim 11, comprising operating the module less frequently for periods when the calibrator indicates that calibration is being performed relatively than a frequency at which the module is operated for periods when the calibration arrangement indicates that calibration is being performed relatively frequently.

17. A method as claimed in claim 11, comprising increasing a frequency of operation of the module in response to a determination that the output of the calibrator indicates that the magnetic field to which the apparatus is exposed has changed from being relatively static to being relatively dynamic.

18. A method as claimed in claim 11, comprising decreasing a frequency of operation of the module in response to a determination that the output of the calibrator indicates that the magnetic field to which the apparatus is exposed has changed from being relatively dynamic to being relatively static.

19. A method as claimed in claim 11, wherein the module is a positioning module.

20. (canceled)

21. A memory storing a program of computer code for controlling computer apparatus, comprising:
computer code configured to receive signals from a magnetometer including a magnetic sensor arrangement, and
computer code configured to control a module having an operation or output dependent on a location of the apparatus dependent on the signals.
